(19) United States
(12) Patent Application Publication
(10) Pub. No.: US 2011/0304606 A1
(43) Pub. Date: Dec. 15, 2011

(54) METHOD AND SYSTEM FOR IMPLEMENTING LOOK-AHEAD PROTECTION IN A COMPUTING DEVICE

(75) Inventor: Richard J. Walsh, Raleigh, NC (US)

(73) Assignee: OTO TECHNOLOGIES, LLC, Raleigh, NC (US)

(21) Appl. No.: 12/814,648

(22) Filed: Jun. 14, 2010

(51) Int. Cl. G09G 5/00

(52) U.S. Cl. 345/214

(57) ABSTRACT

A method and apparatus for presenting a narrative to a user. A focus segment of content is determined, and a first non-focus segment of content that immediately succeeds the focus segment of content is determined. The focus segment of content is displayed on a display. The first non-focus segment of content is displayed on the display with an obscuring characteristic such that the first non-focus segment of content is at least partially obscured compared to the focus segment of content. A segment transition is detected from the focus segment of content to the first non-focus segment of content, and in response to the segment transition, the first non-focus segment of content is displayed on the display without the obscuring characteristic.

### FIELD OF THE DISCLOSURE

The present invention relates to the presentation of a narrative on a computing device, and in particular to implementing look-ahead protection while presenting the narrative on the computing device.

### BACKGROUND

A reader of a narrative, such as a story in a magazine, a book, or a newspaper, is frequently exposed to upcoming content that the reader would have preferred not to have read out of order. Sometimes this is caused simply because it is difficult for a reader to avert their eyes after their peripheral vision has detected something that catches their attention. It may also occur after a reader is interrupted while reading a narrative, and when subsequently attempting to direct their attention back to the point at which they were interrupted, the reader inadvertently turns to a location in the narrative that they had not yet read. Accordingly, there is a need for look-ahead protection that hinders, or inhibits, a reader's ability to glance at portions of a narrative that succeed the portion of the narrative that they are currently reading.

### SUMMARY

Embodiments disclosed herein relate to implementing look-ahead protection during the presentation of content on a display. In one embodiment, a focus segment of content, such as text, that corresponds to a current reading location of a narrative is determined, and a first non-focus segment of content succeeding the focus segment of content is determined. The focus segment of content is displayed on a display to a user. The first non-focus segment of content is displayed with an obscuring characteristic such that the first non-focus segment of content is at least partially obscured compared to the focus segment of content. For example, the first non-focus segment of content may be displayed with an opacity characteristic that substantially increases the opacity of the first non-focus segment of content compared to the focus segment of content. Obscuring the first non-focus segment of content compared to the focus segment of content inhibits the user's ability to inadvertently perceive content that succeeds the content the user is currently reading.

In one embodiment, a segment transition from the focus segment of content to the first non-focus segment of content is detected. For example, the user may tap on a portion of the display in which the first non-focus segment of content is displayed. In response to the segment transition, the first non-focus segment of content is displayed without the obscuring characteristic.

In one embodiment, a plurality of non-focus segments of content are determined, including the first non-focus segment of content which immediately succeeds the focus segment of content. Each of the non-focus segments of content after the first non-focus segment of content succeeds a previous non-focus segment of content. Each of the plurality of non-focus segments of content is displayed with a different obscuring characteristic. For example, each non-focus segment of content may be displayed at a different opacity than each other non-focus segment of content.

In one embodiment, the focus segment of content and first non-focus segment of content are determined based on a content segmentation of the narrative. The content segmentation of the narrative may be predetermined and coupled with the content either directly or indirectly. Alternately, the content segmentation may be dynamic and based on syntax or grammar rules associated with the language in which the content exists. For example, the content may be segmented by sentences or paragraphs.

In another embodiment, the focus segment of content and the first non-focus segment of content are determined based on an area size of a focus region of the display and a non-focus region of the display, respectively. The area size of the focus region is determined, and a focus segment of content at the current reading location of the content that fits within the focus region is determined. A non-focus segment of content succeeding the focus segment of content that will fit within the non-focus region is also determined. The focus segment of content is displayed in the focus region of the display, and the non-focus segment of content is displayed in the non-focus region with an obscuring characteristic such that the first non-focus segment of content is at least partially obscured compared to the focus segment of content.

Those skilled in the art will appreciate the scope of the present disclosure and realize additional aspects thereof after reading the following detailed description of the preferred embodiments in association with the accompanying drawing figures.

### BRIEF DESCRIPTION OF THE DRAWING FIGURES

The accompanying drawing figures incorporated in and forming a part of this specification illustrate several aspects of the disclosure, and together with the description serve to explain the principles of the disclosure.

FIG. 1 is a block diagram of a system in which embodiments may be implemented;

FIGS. 2A-2D illustrate an exemplary electronic reader (E-reader) implementing look-ahead protection according to one embodiment;

FIG. 3 is a flowchart illustrating an exemplary method for implementing look-ahead protection in the E-reader illustrated in FIGS. 2A-2C according to one embodiment;

FIG. 4 is a flowchart illustrating an exemplary method for transitioning from a focus segment of content to a non-focus segment of content according to one embodiment;

FIG. 5 illustrates the system illustrated in FIG. 1 with a segmentation structure that may be used for recording how content is pre-segmented;

FIGS. 6A-6C illustrate an exemplary E-reader implementing look-ahead protection based on content segmentation;

FIG. 7 is a flowchart illustrating an exemplary method for implementing look-ahead protection in the E-reader illustrated in FIGS. 6A-6C based on content segmentation;

FIG. 8 illustrates an exemplary E-reader enforcing a consumption order of the content; and

FIG. 9 illustrates an exemplary computing device that may be used to implement an E-reader according to one embodiment.

### DETAILED DESCRIPTION

The embodiments set forth below represent the necessary information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure and the accompanying claims.

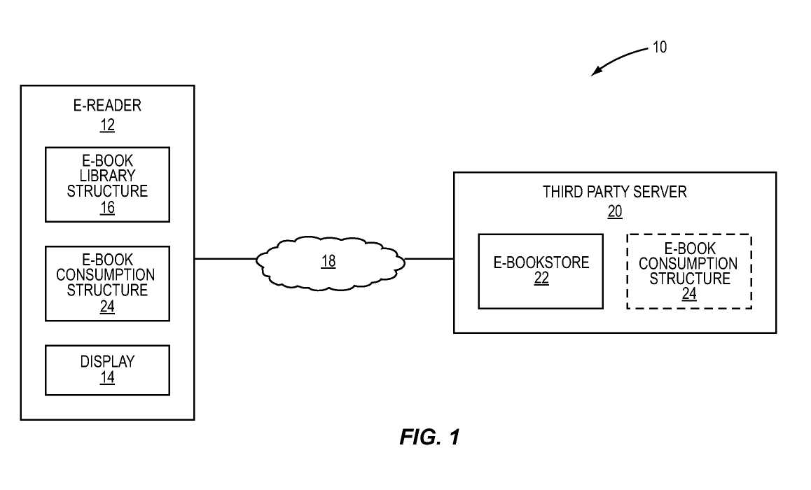

FIG. 1 is a block diagram of a system 10 in which embodiments may be implemented. The system 10 includes a computing device, such as an electronic reader (E-reader) 12, which is capable of displaying a narrative on a display 14. A narrative, as used herein, refers to content such as a book, a magazine article, a newspaper, and other reading material. The E-reader 12 may comprise any computing device capable of displaying a narrative on the display 14, including, for example, a laptop computer, a cellular phone, a smart phone, a personal digital assistant (PDA), an Apple® iPad™, an Amazon® Kindle™, a Barnes & Noble® Nook™, or the like.

The E-reader 12 may include an electronic book (e-book) library structure 16 where one or more narratives may be stored. The phrase “e-book” will be used herein to refer to any type of electronic narrative, including books, magazines, newspapers, articles, and the like. The E-reader 12 may also include a network interface that is adapted to communicate with a network 18. Via the network 18, the E-reader 12 may communicate with a third party server 20 of an e-book provider. The E-reader 12 may be able to download e-books that are purchased or rented from an e-bookstore 22 on the third party server 20.

The E-reader 12 may also include an e-book consumption structure 24 which records a current reading location of the narratives in the e-book library structure 16. Upon receiving a request by a user to consume an e-book contained in the e-book library structure 16, the E-reader 12 may access the e-book consumption structure 24 and determine the location in the selected e-book where the user was last reading. The E-reader 12 can then open the selected e-book at such location for the convenience of the user. Alternately, the e-book consumption structure 24 may be located on an external computing device, such as the third party server 20.

Embodiments disclosed herein relate to implementing look-ahead protection during the presentation of content on the display 14. In one embodiment, a focus segment of content, such as text, that corresponds to a current reading location of the narrative is determined, and a first non-focus segment of content succeeding the focus segment of content is determined. The focus segment of content is displayed on the display 14 to the user. The first non-focus segment of content is displayed with an obscuring characteristic such that the first non-focus segment of content is at least partially obscured compared to the focus segment of content. For example, the first non-focus segment of content may be displayed with an opacity characteristic that substantially increases the opacity of the first non-focus segment of content compared to the focus segment of content. Obscuring the first non-focus segment of content compared to the focus segment of content inhibits the user's ability to inadvertently perceive content that succeeds the content the user is currently reading.

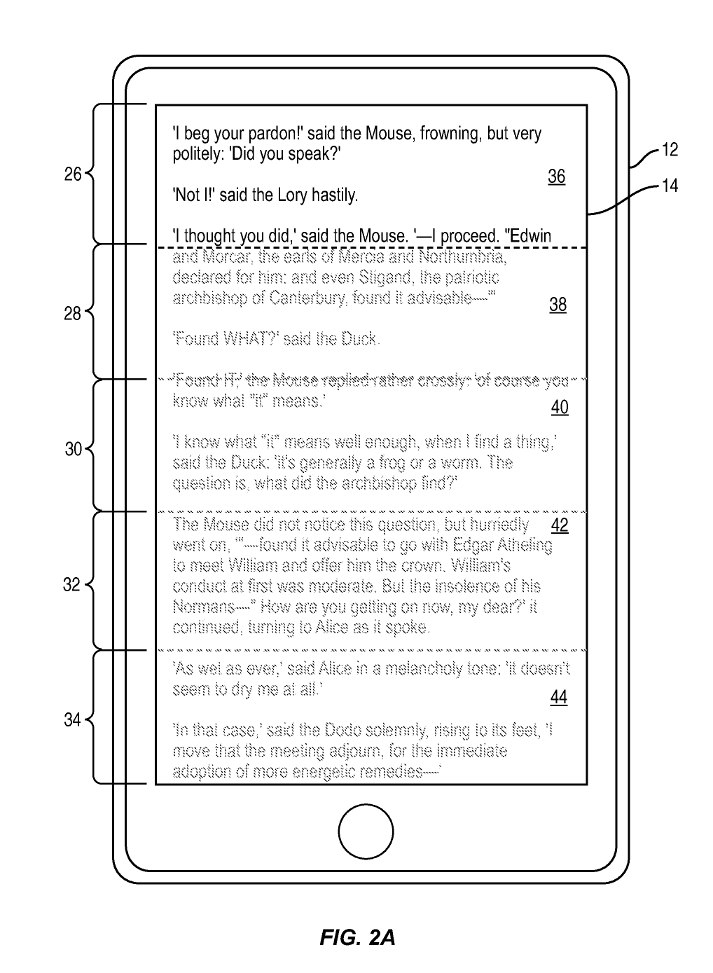

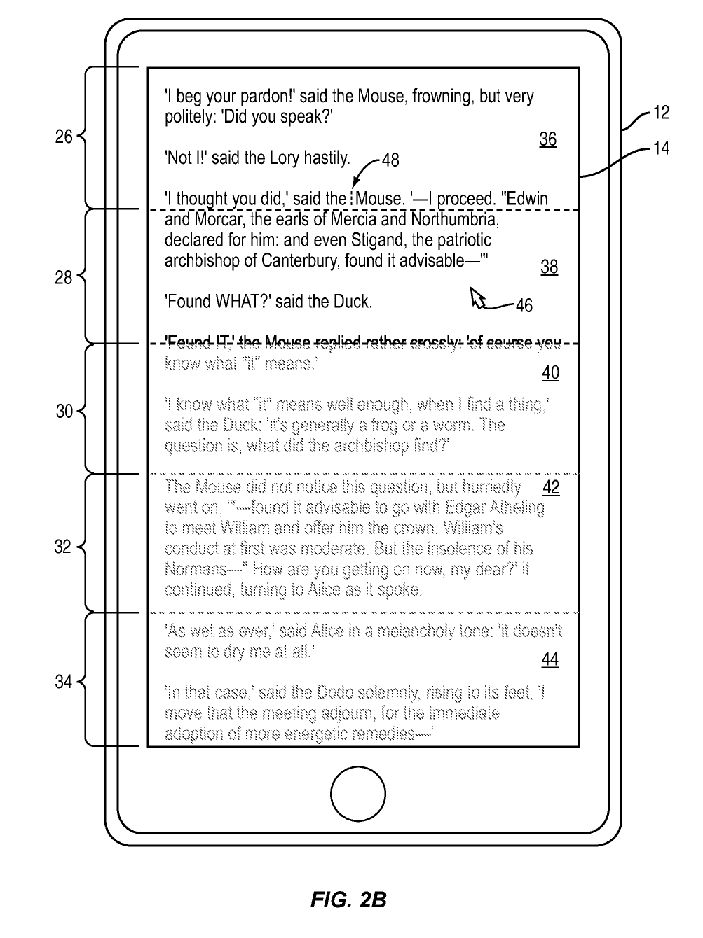

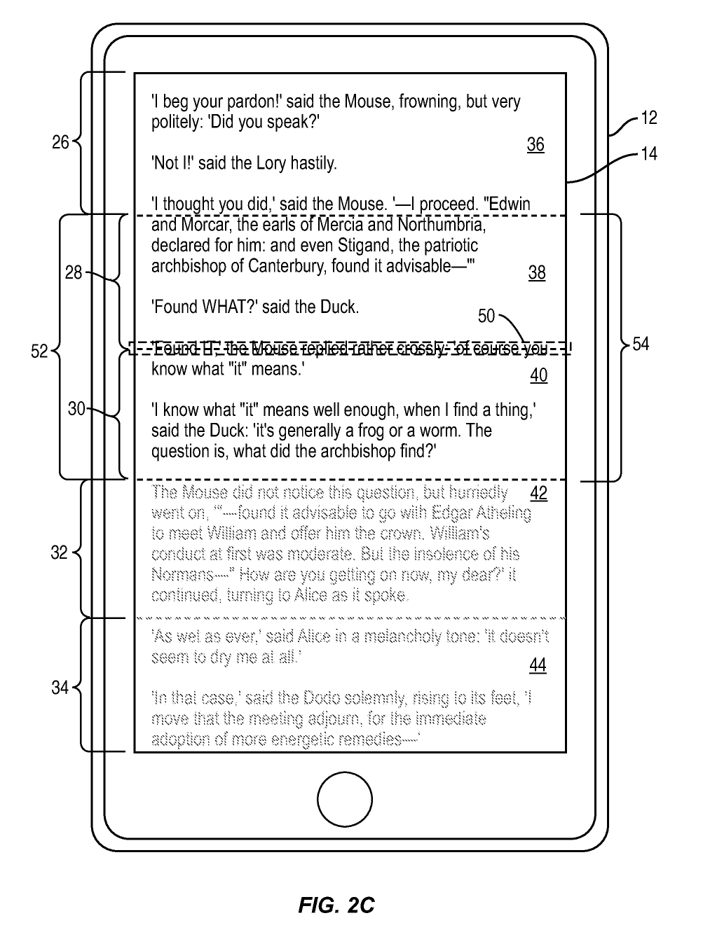

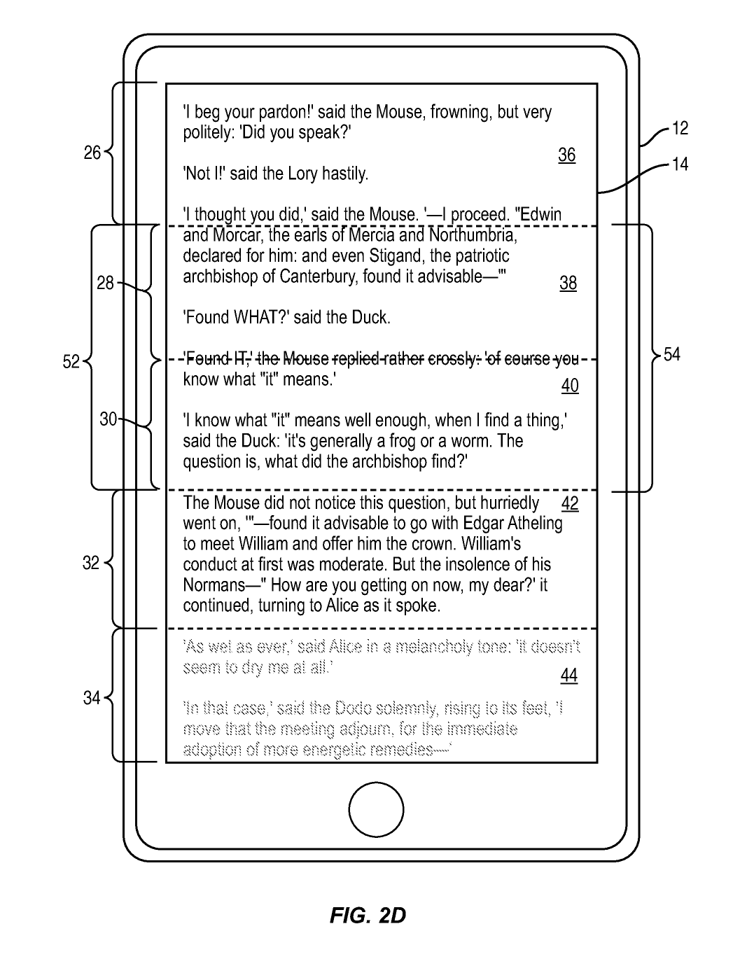

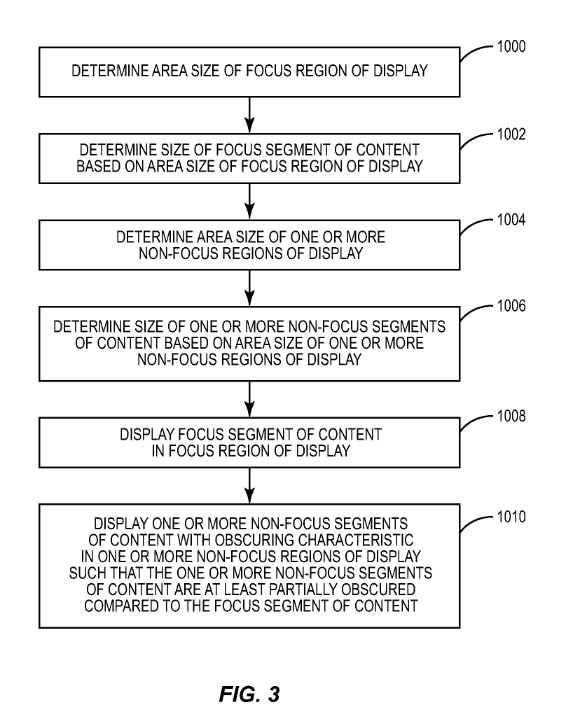

FIGS. 2A-2D illustrate an exemplary E-reader 12 implementing look-ahead protection according to one embodiment. FIG. 3 is a flowchart illustrating an exemplary method for implementing look-ahead protection in the E-reader 12 according to one embodiment. FIG. 2A will be discussed in conjunction with FIG. 3.

Referring first to FIGS. 2A and 3, in one embodiment, the focus segment of content is determined based at least in part on an area size of a focus region 36 of the display 14 (FIG. 3, step 1000). In particular, the E-reader 12 may divide the area size of the display 14 into the focus region 36 and one or more non-focus regions 38-44. The division of the area size of the display 14 into the focus region 36 and one or more non-focus regions 38-44 may be predetermined, user configurable, based on the font size of the content, or the like. The E-reader 12 then determines the current reading location of the user, and based on attributes of the content, such as font size, zoom factor, and the like, determines an amount of content that can be displayed within the focus region 36. Based on these factors, the E-reader 12 determines the focus segment of content 26 (FIG. 3, step 1002). It should be noted that the dashed lines illustrating the focus region 36 and non-focus regions 38-44 are for purposes of illustration, and in practice would preferably not be displayed on the display 14.

The current reading location of the user may be obtained based on actions of the user which indicate to the E-reader 12 when the user is transitioning from a focus segment of content to an immediately succeeding non-focus segment of content. When the narrative is initially opened for presentation to the user, the current reading location may be obtained from the e-book consumption structure 24. If the narrative is being opened for the first time, a default initial current reading location may be assumed, such as the beginning paragraph of the narrative.

The E-reader 12 then determines the area size of the one or more non-focus regions 38-44 of the display 14 (FIG. 3, step 1004). Based on the area size of the one or more non-focus regions 38-44, the E-reader 12 determines the size of one or more non-focus segments of content 28-34 (FIG. 3, step 1006).

The focus segment of content 26 is then displayed in the focus region 36 of the display 14 (FIG. 3, 1008). The non-focus segments of content 28-34 are then displayed with an obscuring characteristic on the display 14 such that the non-focus segments of content 28-34 are at least partially obscured compared to the focus segment of content 26 (FIG. 3, step 1010). A first non-focus segment of content 28 immediately succeeds the focus segment of content 26, and the remainder of the plurality of non-focus segments 30-34 immediately succeeds a preceding non-focus segment of content 28-32, respectively.

Obscuring characteristics can comprise any suitable characteristic for diminishing the visibility of the non-focus segments of content 28-34 with respect to the focus segment of content 26, such as, for example, an opacity characteristic of the content which makes the content more opaque than the focus segment of content 26, a blurring characteristic which blurs the content compared to the focus segment of content 26, a text or background color characteristic which decreases the contrast between the content and the background, and the like.

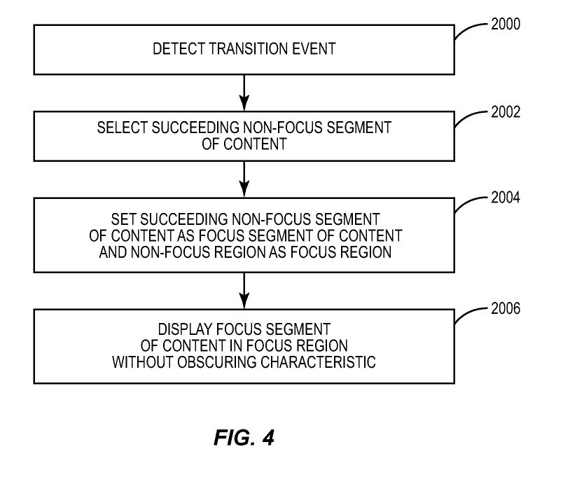

FIG. 2B illustrates a segment transition from a focus segment of content to a non-focus segment of content according to one embodiment. FIG. 4 is a flowchart illustrating an exemplary method for transitioning from a focus segment of content to a non-focus segment of content according to one embodiment. FIG. 2B will be discussed in conjunction with FIG. 4.

The E-reader 12 detects a segment transition based on an action of the user that indicates the user is ready to advance from the focus segment of content 26 to the non-focus segment of content 28 (FIG. 4, step 2000). The action may comprise detecting input by the user, such as the placement of a cursor 46 over the non-focus region 38 in which the first non-focus segment of content 28 is displayed with the obscuring characteristic, followed by a mouse click by the user. Alternatively, if the display 14 is a touch-enabled display, the user may simply tap the display 14 somewhere in the non-focus region 38 of the display 14. In another embodiment, a touch-enabled display 14 may detect a movement of a user's finger sliding across the display 14 from the focus region 36 to the first non-focus region 38. In yet another embodiment, the E-reader 12 may include gaze-detection technology which determines a location of a gaze of the user with respect to the display 14. The E-reader 12 may designate a particular location, such as location 48, in the focus region 36 in which an end portion of the focus segment of content 26 is displayed, as a segment transition trigger location. The E-reader 12 detects the user's gaze crossing the location 48 and triggers a segment transition from the focus segment of content 26 to at least the first non-focus segment of content 28.

Upon detecting the segment transition, the E-reader 12 selects the succeeding non-focus segment of content 28 for display (FIG. 4, step 2002). The succeeding non-focus segment of content 28 is then set to be the current focus segment of content, and the non-focus region 38 is set to be the current focus region (FIG. 4, step 2004). The E-reader 12 then displays the focus segment of content 28 in the focus region 38 without the obscuring characteristic (FIG. 4, step 2006).

FIG. 2C illustrates another embodiment wherein the E-reader 12 aggregates two non-focus segments of content. Assume again that the E-reader 12 detects a segment transition based on an action of the user that indicates the user is ready to advance from the focus segment of content 26 to the non-focus segment of content 28. However, the E-reader 12 determines that based on the formatting of the non-focus segment of content 28 and the area size of the non-focus region 38, a portion of the non-focus segment of content 28, as illustrated by box 50, will be displayed clearly, and a portion will be displayed with an obscuring characteristic. Because this may be distracting to a user, the E-reader 12 aggregates the non-focus segment of content 28 with the non-focus segment of content 30 into a single non-focus segment of content 52 for display in the non-focus regions 38 and 40, respectively. The non-focus segment of content 52 is then set to be the current focus segment of content, and a non-focus region 54 is set to be the current focus region. The E-reader 12 then displays the focus segment of content 52 in the focus region 54 without the obscuring characteristic.

FIG. 2D illustrates a transition from the focus segment of content 52 to the non-focus segment of content 32. The E-reader 12 detects a segment transition based on an action of the user that indicates the user is ready to advance from the focus segment of content 52 to the non-focus segment of content 32. The E-reader 12 selects the succeeding non-focus segment of content 32 for display. The non-focus segment of content 32 is then set to be the current focus segment of content, and the non-focus region 42 is set to be the current focus region. The E-reader 12 then displays the focus segment of content 32 in the focus region 42 without the obscuring characteristic.

In one embodiment, the non-focus segments of content 28-34 may be obscured differently from one another. For example, using opacity for illustration purposes, assume that opacity may be defined by an opacity level that is in a range from 0-100, wherein an opacity level of 0 means the content is not opaque, and an opacity level of 100 means the content is completely opaque and cannot be viewed on the display 14. The non-focus segment of content 28 may be set at an opacity level of 20%, such that the non-focus segment of content 28 may be perceived relatively easily on the display 14, but not as easily as the focus segment of content 26 which is displayed without any obscuring characteristic. The non-focus segment of content 30 may be set at an opacity level that is substantially greater than that of the opacity level of the non-focus segment of content 28, such as an opacity level of 40%. The non-focus segment of content 32 may be set at an opacity level of 60%, and the non-focus segment of content 34 may be set at an opacity level of 80%. In this manner, the content that is further away from the focus segment of content 26 becomes increasingly difficult to read.

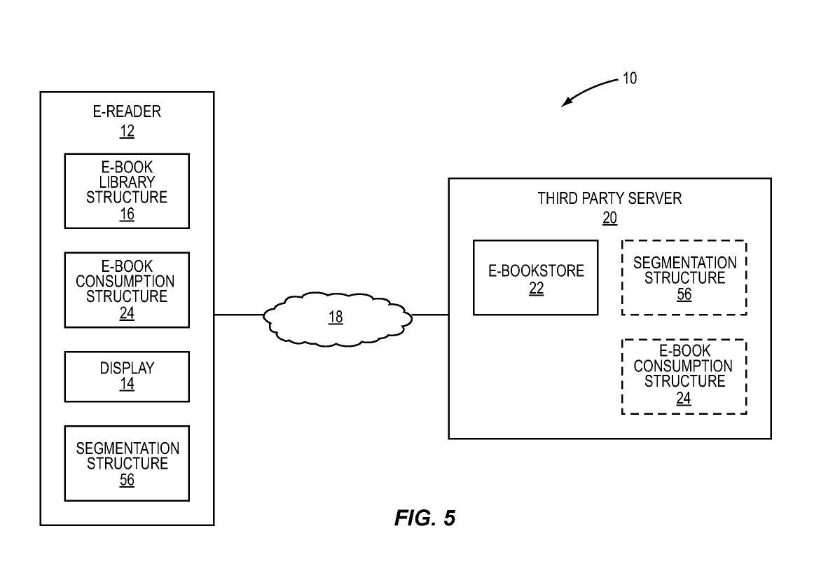

In another embodiment, content segmentation is based, at least in part, on the content itself. The content may be pre-segmented, or may be dynamically segmented by the E-reader 12 as the content is being consumed by the user. FIG. 5 illustrates the system 10 illustrated in FIG. 1 with a segmentation structure 56 that may be used for recording how content is pre-segmented. The segmentation structure 56 may reside on the E-reader 12, or may be stored on the third party server 20. The segmentation structure 56 contains information that defines how the content associated with one or more narratives in the e-book library structure 16 are segmented. This information could be downloaded at the same time a narrative is purchased or leased from the e-bookstore 22. The segmentation structure 56 may identify the segmentation via any suitable reference information that may define segmentation of a corresponding narrative by words, sentences, paragraphs, and the like. For example, the segmentation structure 56 may contain a list of records that define consecutive segments for an narrative. Each record may define a segment via a word number offset of the first word of the segment and a word number offset of the final word of the segment, wherein each word number offset is the offset of a particular word starting with the first word of the narrative.

Alternately, the segmentation information may be contained in the narrative itself, and denoted by predetermined begin-segment and end-segment identifiers that respectively precede and succeed each segment of content. In yet another embodiment, the E-reader 12 may determine the segmentation based on rules of grammar and syntax associated with the particular language in which the narrative is written. For example, the segmentation may be based on sentences, or paragraphs. In yet another embodiment, a semantic analysis may be performed on the content to segment the content based on what is determined to be related subject matter. In particular, an ontology, or other semantic knowledge store, may be used to determine the context of the content, and segment the content in accordance with such context.

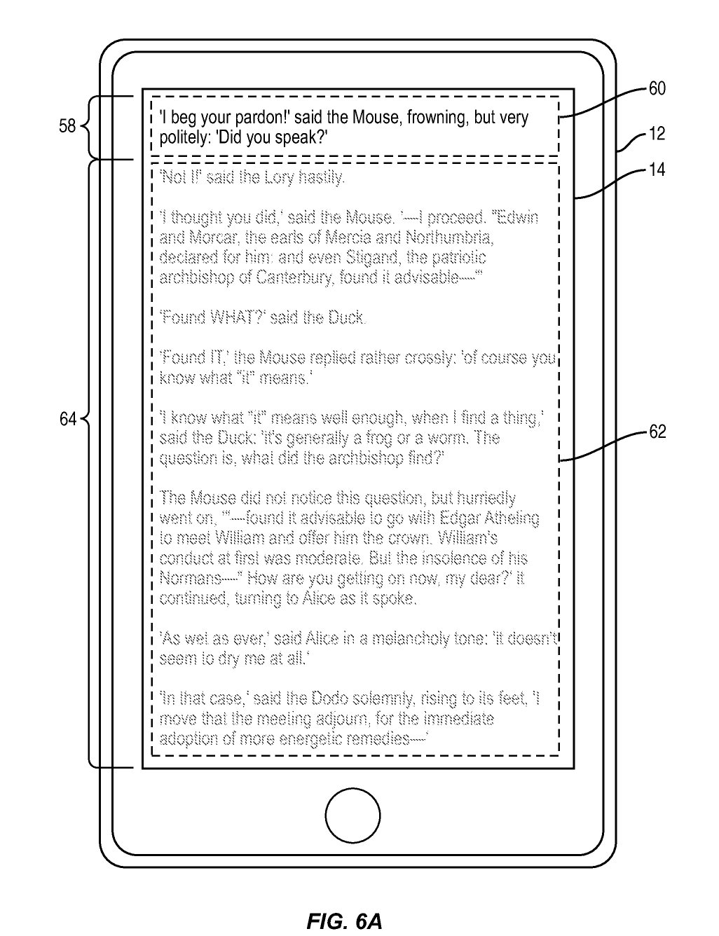

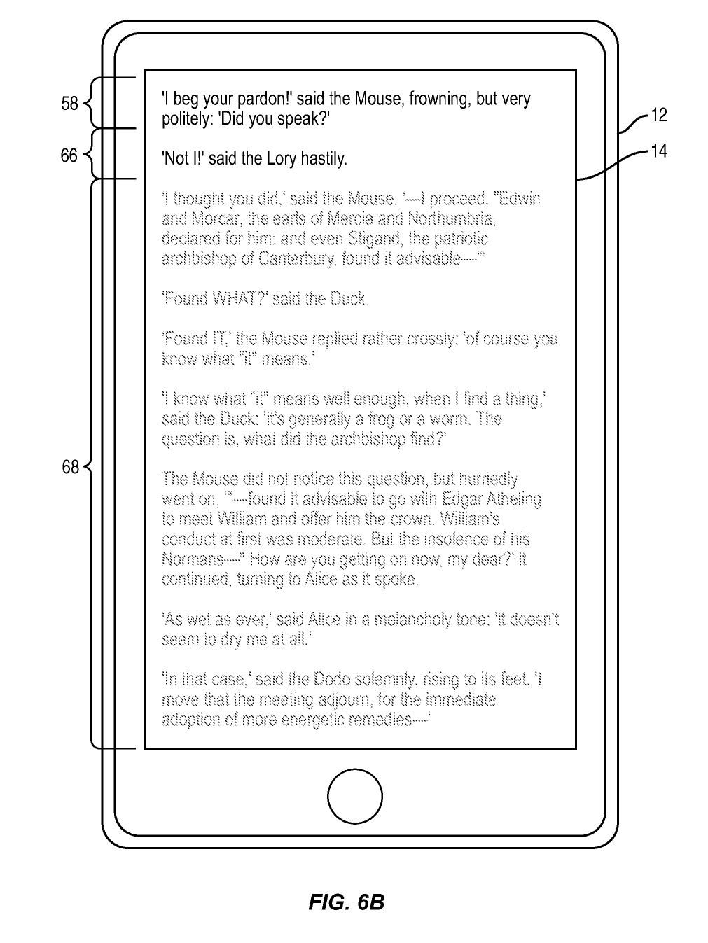

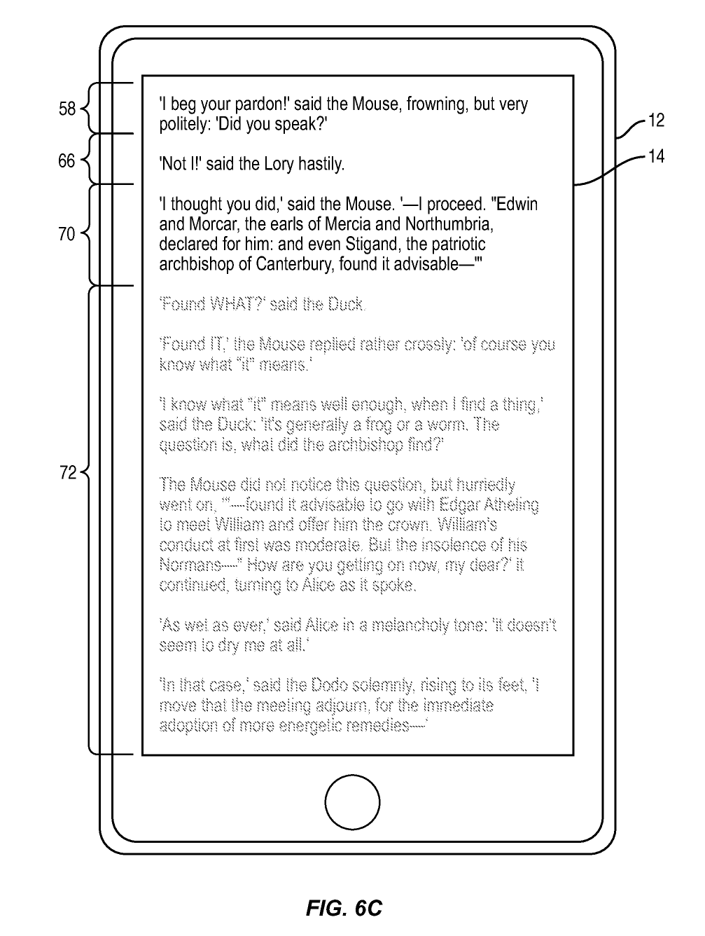

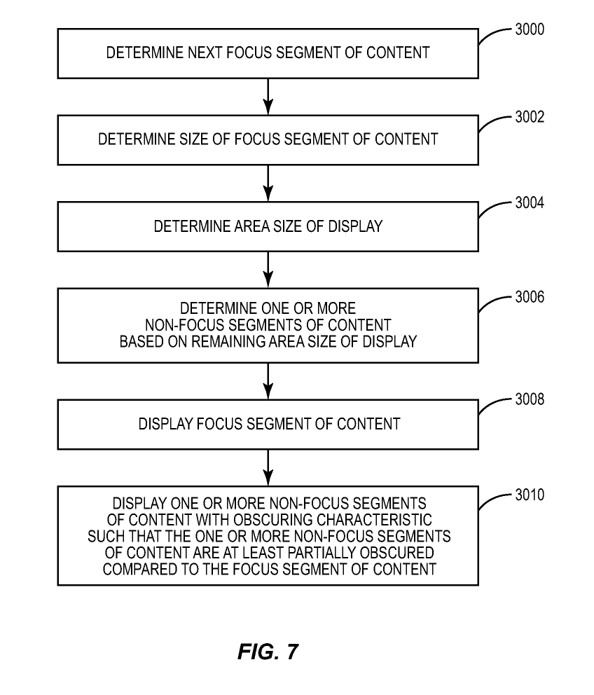

FIGS. 6A-6C illustrate an exemplary E-reader 12 implementing look-ahead protection based on content segmentation, and FIG. 7 is a flowchart illustrating an exemplary method for implementing look-ahead protection based on content segmentation. FIG. 6A will be discussed in conjunction with FIG. 7. The E-reader 12 determines the next focus segment of content 58 (FIG. 7, step 3000). This may be determined, as discussed previously, via information contained in the segmentation structure 56 (FIG. 5), via segmentation information contained in the narrative, or based on dynamic content segmentation performed by the E-reader 12 as the narrative is being consumed. The E-reader 12 then determines a size of a focus segment of content 58 based on attributes that relate to the size of the focus segment of content 58 when displayed on the display 14, such as font size, font type, current zoom factor, and the like (FIG. 7, step 3002).

The E-reader 12 determines an area size 60 of the display 14 in which the focus segment of content 58 will be displayed (FIG. 7, step 3004). The E-reader 12 can then determine one or more non-focus segments of content 64 which can be displayed with an obscuring characteristic in a remaining area size 62 of the display (FIG. 7, step 3006). The E-reader 12 displays the focus segment of content 58 on the display 14 (FIG. 7, step 3008). The E-reader 12 also displays the one or more non-focus segments of content 64 with an obscuring characteristic such that the one or more non-focus segments of content 64 are at least partially obscured compared to the focus segment of content 58 (FIG. 7, step 3010).

FIG. 6B illustrates a segment transition from the focus segment of content 58 to an immediately succeeding non-focus segment of content 66. The E-reader 12 detects a segment transition based on an action of the user that indicates the user is ready to advance from the focus segment of content 58 to the non-focus segment of content 66. The E-reader 12 selects the succeeding non-focus segment of content 66 for display. The non-focus segment of content 66 is then set to be the current focus segment of content. The E-reader 12 then displays the focus segment of content 66 on the display 14 without any obscuring characteristic. One or more non-focus segments of content 68 are displayed with an obscuring characteristic such that the one or more non-focus segments of content 68 are at least partially obscured compared to the focus segment of content 66.

FIG. 6C illustrates another segment transition from the focus segment of content 66 to an immediately succeeding non-focus segment of content 70. The E-reader 12 detects a segment transition based on an action of the user that indicates the user is ready to advance from the focus segment of content 66 to the non-focus segment of content 70. The E-reader 12 selects the succeeding non-focus segment of content 70 for display. The non-focus segment of content 70 is then set to be the current focus segment of content. The E-reader 12 then displays the focus segment of content 70 on the display 14 without any obscuring characteristic, and displays one or more non-focus segments of content 72 with an obscuring characteristic such that the one or more non-focus segments of content 72 are at least partially obscured compared to the focus segment of content 70.

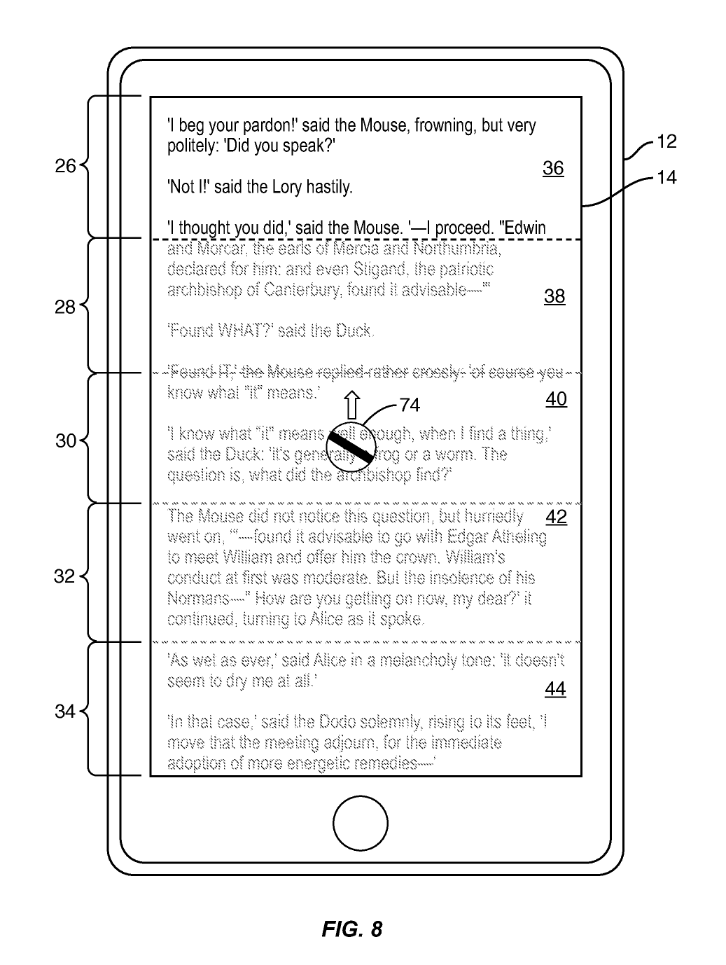

FIG. 8 illustrates an exemplary E-reader 12 enforcing a consumption order of the content. The E-reader 12 detects that the user is attempting to transition to a non-focus segment of content 30 that is not the non-focus segment of content that immediately succeeds the focus segment of content 26. For example, the user may have placed the cursor over the non-focus region 40 in which the non-focus segment of content 30 is displayed, and clicked the mouse button. Alternatively, if the display 14 is a touch-enabled display, the user may have tapped the display 14 somewhere in the non-focus region 40. If the E-reader 12 includes gaze technology, the user may have focused on the non-focus region 40 rather than the non-focus region 38. Upon detecting this attempt to transition to the non-focus segment of content 30, the E-reader 12 alerts the user that the attempted transition would be out-of-order. The alert may comprise any suitable error message, such as a sound, a flashing of the screen, or the E-reader 12 may display a graphic image 74 that indicates that the attempted transition is out-of-order, which directs the user's attention to the correct non-focus segment of content 28.

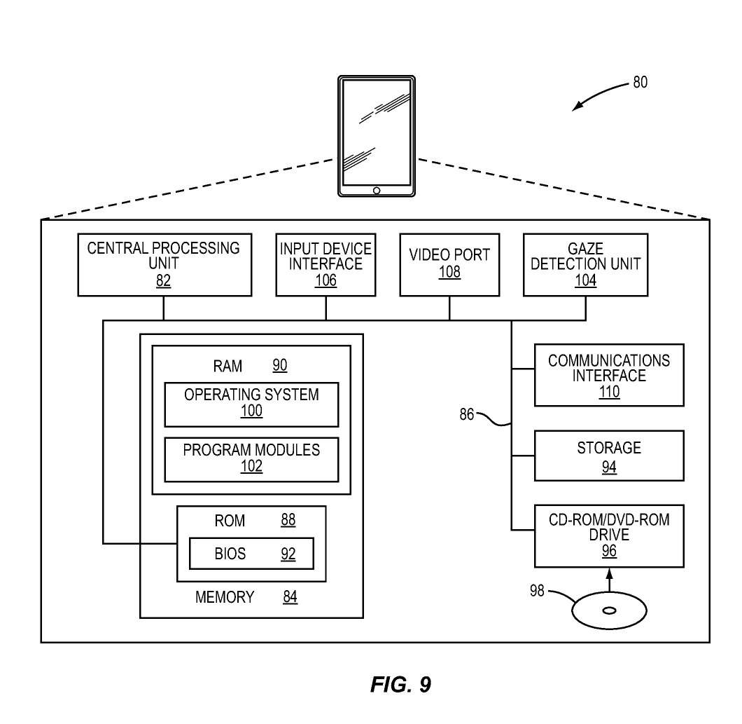

FIG. 9 illustrates an exemplary computing device 80 that may be used to implement an E-reader 12 according to one embodiment. The computing device 80 may, for example, comprise a laptop computer, a cellular phone, a smart phone, a personal digital assistant (PDA), an Apple® iPad™, an Amazon® Kindle™, a Barnes & Noble® Nook™, or the like. In addition to components discussed previously herein, the exemplary computing device 80 may also include a central processing unit 82, a system memory 84, and a system bus 86. The system bus 86 provides an interface for system components including, but not limited to, the system memory 84 and the central processing unit 82. The central processing unit 82 can be any of various commercially available or proprietary processors. Dual microprocessors and other multi-processor architectures may also be employed as the central processing unit 82.

The system bus 86 can be any of several types of bus structures that may further interconnect to a memory bus (with or without a memory controller), a peripheral bus, and a local bus using any of a variety of commercially available bus architectures. The system memory 84 can include non-volatile memory 88 (e.g., read only memory (ROM), erasable programmable read only memory (EPROM), electrically erasable programmable read only memory (EEPROM), etc.) and/or volatile memory 90 (e.g., random access memory (RAM)). A basic input/output system (BIOS) 92 can be stored in the non-volatile memory 88, and can include the basic routines that help to transfer information between elements within the computing device 80. The volatile memory 90 can also include a high-speed RAM such as static RAM for caching data.

The computing device 80 may further include a storage 94, which may comprise, for example, an internal hard disk drive (HDD) (e.g., enhanced integrated drive electronics (EIDE) or serial advanced technology attachment (SATA)) for storage, for storing the e-book library structure 16, the e-book consumption structure 24, the segmentation structure 56, and the like. The computing device 80 may further include an optical disk drive 96 (e.g., for reading a compact disc (CD), digital video disc (DVD), or other optical media 98). The drives and associated computer-readable or computer-usable media provide non-volatile storage of data, data structures, computer-executable instructions, and so forth. For the computing device 80, the drives and media accommodate the storage of any data in a suitable digital format. Although the description of computer-readable media above refers to an HDD and optical media such as a CD or DVD, it should be appreciated by those skilled in the art that other types of media which are readable by a computer, such as Zip disks, magnetic cassettes, flash memory cards, cartridges, and the like, may also be used in the exemplary operating environment, and further, that any such media may contain computer-executable instructions for performing novel methods of the disclosed architecture.

A number of program modules can be stored in the drives and volatile memory 90, including an operating system 100 and one or more program modules 102, which implement the functionality described herein, including, for example, functionality associated with the determination of focus and non-focus segments of content, display of the focus and non-focus segments of content, transition detection, and other associated processing and functionality described herein. It is to be appreciated that the embodiments can be implemented with various commercially available operating systems or combinations of operating systems. All or a portion of the embodiments may be implemented as a computer program product, such as a computer-usable or computer-readable medium having a computer-readable program code embodied therein. The computer-readable program code can include software instructions for implementing the functionality of the embodiments described herein. The central processing unit 82, in conjunction with the program modules 102 in the volatile memory 90, may serve as a control system for the computing device 80 that is configured to, or adapted to, implement the functionality described herein.

A user may be able to enter commands and information into the computing device 80 through one or more wired or wireless input devices, for example, a keyboard and a pointing device, such as a mouse (not illustrated), or via the display 14 where the display 14 is a touch screen. The computing device 80 may also include a gaze detection unit 104 that is adapted to, or configured for, detecting a location of a user's gaze on the display 14. Other input devices (not illustrated) may include a microphone, an infrared (IR) remote control, a joystick, a game pad, a stylus pen, or the like. These and other input devices are often connected to the central processing unit 82 through an input device interface 106 that is coupled to the system bus 86 but can be connected by other interfaces, such as a parallel port, an IEEE 1394 serial port, a game port, a universal serial bus (USB) port, an IR interface, etc.

The computing device 80 may drive a separate or integral display 14, which may also be connected to the system bus 86 via an interface, such as a video port 108. The computing device 80 operates in a networked environment using a wired and/or wireless network communications interface 110. The communications interface 110 can facilitate wired and/or wireless communications to the network 18 (FIG. 1).

The computing device 80 may be operable to communicate with any wireless devices or entities operatively disposed in wireless communication, for example, a printer, a scanner, or a desktop or portable computer, via wireless technologies, such as Wi-Fi® and Bluetooth®, for example.

While embodiments described herein have been with respect to a narrative written in the English language, and thus content has been described as being presented from top to bottom and left to right in accordance with normal content presentation order associated with the English language, those of skill in the art will appreciate that the embodiments disclosed herein can be utilized with narratives that present content in any order. For example, a comic book may present content in an unconventional order, such as beginning in the center of the display 14 and spiraling outwards. Other languages may present content from right to left, and/or from bottom to top. Irrespective of the particular content order, embodiments disclosed herein may be used to implement look-ahead protection for a narrative that presents content in any reading order.

Those skilled in the art will recognize improvements and modifications to the preferred embodiments of the present disclosure. All such improvements and modifications are considered within the scope of the concepts disclosed herein and the claims that follow.

What is claimed is:

1. A computer-implemented method for presenting a narrative to a user, comprising:
determining, on a computing device, a focus segment of content;
determining a first non-focus segment of content that immediately succeeds the focus segment of content;
displaying the focus segment of content on a display;
displaying the first non-focus segment of content on the display with an obscuring characteristic such that the first non-focus segment of content is at least partially obscured compared to the focus segment of content;
detecting a segment transition from the focus segment of content to the first non-focus segment of content; and
in response to the segment transition, displaying the first non-focus segment of content on the display without the obscuring characteristic.

2. The method of claim 1, wherein a size of the focus segment of content is based on a content segmentation of the narrative.

3. The method of claim 2, further comprising accessing a content segmentation structure that defines content segments of the narrative, and wherein the size of the focus segment of content is obtained from the content segmentation structure.

4. The method of claim 1, wherein a size of the focus segment of content is based on a size of a focus region of the display.

5. The method of claim 4, further comprising determining a non-focus region area size of the display, and wherein determining the first non-focus segment of content that immediately succeeds the focus segment of content further comprises determining the first non-focus segment of content that immediately succeeds the focus segment of content and that can be displayed within the non-focus region area size.

6. The method of claim 1, wherein detecting the segment transition from the focus segment of content to the first non-focus segment of content comprises determining a first gaze location with respect to the display, and detecting a second gaze location with respect to the display that is in an area of the display wherein the non-focus segment of content is displayed.

7. The method of claim 1, wherein detecting the segment transition from the focus segment of content to the first non-focus segment of content comprises receiving user input selecting a location of the display that is in an area of the display wherein the non-focus segment of content is displayed.

8. The method of claim 1, wherein the obscuring characteristic comprises a content opacity characteristic that is substantially greater than a content opacity characteristic of the focus segment of content.

9. The method of claim 1, wherein:
determining the first non-focus segment of content that immediately succeeds the focus segment of content further comprises determining a plurality of non-focus segments of content that succeed the focus segment of content, wherein the plurality of non-focus segments of content includes the first non-focus segment of content; and further comprising:
detecting an attempted transition from the focus segment of content to one of the plurality of non-focus segments of content other than the first non-focus segment of content; and
in response thereto, displaying an error message on the display.

10. The method of claim 1, wherein:
determining the first non-focus segment of content that immediately succeeds the focus segment of content further comprises determining a plurality of non-focus segments of content that succeed the focus segment of content, wherein the plurality of non-focus segments of content includes the first non-focus segment of content;
wherein displaying the first non-focus segment of content on the display with the obscuring characteristic such that the first non-focus segment of content is at least partially obscured with respect to the focus segment of content further comprises displaying each of the plurality of non-focus segments of content on the display with the obscuring characteristic such that each of the plurality of non-focus segments of content is at least partially obscured with respect to the focus segment of content; and
wherein the obscuring characteristic of each of the non-focus segments of content differs from the obscuring characteristic of each of the other non-focus segments of content.

11. A computing device, comprising:
a communications interface adapted to communicate with a network; and
a control system coupled to the communications interface and configured to:
determine a focus segment of content;
determine a first non-focus segment of content that immediately succeeds the focus segment of content;
display the focus segment of content on a display;
display the first non-focus segment of content on the display with an obscuring characteristic such that the first non-focus segment of content is at least partially obscured compared to the focus segment of content;
detect a segment transition from the focus segment of content to the first non-focus segment of content; and
in response to the segment transition, display the first non-focus segment of content on the display without the obscuring characteristic.

12. The computing device of claim 11, wherein a size of the focus segment of content is based on a content segmentation of a narrative.

13. The computing device of claim 12, wherein the control system is further configured to access a content segmentation structure that defines content segments of the narrative, and wherein the size of the focus segment of content is obtained from the content segmentation structure.

14. The computing device of claim 11, wherein a size of the focus segment of content is based on a size of a focus region of the display.

15. The computing device of claim 11, wherein the obscuring characteristic comprises a content opacity characteristic that is substantially greater than a content opacity characteristic of the focus segment of content.

16. The computing device of claim 11, wherein:
to determine the first non-focus segment of content that immediately succeeds the focus segment of content, the control system is further configured to determine a plurality of non-focus segments of content that succeed the focus segment of content, wherein the plurality of non-focus segments of content includes the first non-focus segment of content; and wherein the control system is further configured to:
detect an attempted transition from the focus segment of content to one of the plurality of non-focus segments of content other than the first non-focus segment of content; and
in response thereto, display an error message on the display.

17. A computer program product, comprising a computer-usable medium having a computer-readable program code embodied therein, the computer-readable program code adapted to be executed on a processor to implement a method for presenting a narrative to a user, the method comprising:
determining, on a computing device, a focus segment of content;
determining a first non-focus segment of content that immediately succeeds the focus segment of content;
displaying the focus segment of content on a display;
displaying the first non-focus segment of content on the display with an obscuring characteristic such that the first non-focus segment of content is at least partially obscured compared to the focus segment of content;
detecting a segment transition from the focus segment of content to the first non-focus segment of content; and
in response to the segment transition, displaying the first non-focus segment of content on the display without the obscuring characteristic.

18. The computer program product of claim 17, wherein a size of the focus segment of content is based on a content segmentation of the narrative.

19. The computer program product of claim 18, wherein the method further comprises accessing a content segmentation structure that defines content segments of the narrative, and wherein the size of the focus segment of content is obtained from the content segmentation structure.

20. The computer program product of claim 17, wherein a size of the focus segment of content is based on a size of a focus region of the display.
